(19) United States
(12) Patent Application Publication
(10) Pub. No.: US 2018/0193994 A1
(43) Pub. Date: Jul. 12, 2018

(54) PORTABLE POWER TOOL COMPRISING AN EPICYCLIC REDUCTION GEAR

(71) Applicant: PELLENC (Societe Anonyme), Pertuis (FR)

(72) Inventor: Roger PELLENC, Pertuis (FR)

(21) Appl. No.: 15/567,528

(22) PCT Filed: Jun. 15, 2016
(86) PCT No.: PCT/FR2016/051441

§ 371 Date: Jan. 8, 2018

(30) Foreign Application Priority Data
Jun. 24, 2015 (FR) 15/55818

(51) Int. Cl. B25F 5/00; B23D 29/00; A01G 3/037

(52) U.S. Cl. CPC B25F 5/001; A01G 3/037; B23D 29/005

(57) ABSTRACT

A portable power tool including, within a housing: an electric motor having a drive shaft, an epicyclic reduction gear having planetary gears meshing with a central gear of the drive shaft of the electric motor, the reduction gear being provided with an output shaft that is rigidly connected to a ball screw of a ball screw/nut mechanism and is coaxial to the ball screw, and a support bearing connecting the output shaft to the housing. The tool includes at least one stabilization bearing axially offset relative to the support bearing. The stabilization bearing connects the output shaft of the epicyclic reduction gear to the housing by at least one intermediate part selected from: the drive shaft of the electric motor, planet-carrier axles of the epicyclic reduction gear, and epicyclic reduction gears of the epicyclic reduction gear. The structure is of use in shears, in particular sheet metal shears.

### TECHNICAL FIELD

The present invention concerns a portable power tool and more precisely, such a tool utilizing a transmission to transform the rotary motion of an electric motor into a longitudinal movement of translation of an active element such as, for example, a transmission comprising a mechanism of the ball screw-nut type.

The invention finds general applications in the production of transmission mechanisms and in the manufacture of portable power tools using a mechanism transforming a rotary movement of a motor into a longitudinal movement of translation such as, for example, the one provided by a ball screw-nut mechanism. The invention finds applications particularly in the manufacture of pruning shears or sheet metal shears.

### State of Prior Art

Portable power tools such as pruning shears and sheet metal shears generally feature a housing forming a handle. The housing serves as support for a cutting element and accommodates an electric motor for activating the cutting element. In the case of an electric pruning shear, the cutting element comprises typically a jaw with a fixed blade called a hook, and a cutting blade moving around a blade pivot enabling it to pivot in relation to the hook. Closing the cutting blade on the hook allows cutting a branch or a shoot caught between the blade and the hook.

A mechanical transmission is used for transmitting the movement of the motor to the cutting blade.

The transmission usually comprises a mechanical reduction gear driven in rotation by the motor. It is, for example, an epicyclic reduction gear with planet pinions.

The reduction gear drives a ball screw of the ball screw-nut mechanism. It makes it possible to drive the ball screw at a reduced rotary speed relative to the rotary speed of the electric motor. It also allows increasing the rotary torque.

The essential function of the ball screw-nut mechanism is to convert the rotary movement of the motor and the reduction gear into a translatory motion. The ball nut and the ball screw present complementary helical grooves which face each other and form a ball circulation path. The rotation of the ball screw provokes the circulation of the balls in the raceway and the displacement of the nut along the screw axis. The mechanical stresses of the movement are transmitted from the screw to the nut through the intermediary of the balls. The rotary sense of the screw, clockwise or counterclockwise, determines the direction of axial displacement of the nut. The nut is thus animated by a translatory movement.

The translatory movement of the ball nut is then transmitted to a cam of the cutting element. This occurs through the intermediary of rods mounted on the nut and linked to the cam, for example, through a cam pivot. The cam notably enables a cutting blade to pivot through a lever effect between the cam pivot and the blade pivot. The direction of displacement of the ball nut along the ball screw determines the pivoting direction of the blade, either to open the cutting element or to close it. In the case of a pruning shear, the opening of the cutting element corresponds to a pivoting of the mobile blade which moves it away from the hook. By closing the cutting element the blade is being moved toward the hook.

Such a tool is described, for example, in document FR2614568.

One of the difficulties encountered with transmissions of this type is the axial and radial maintenance of the ball screw. The ball screw essentially sustains axial loads corresponding to the loads of opening and even more to the loads of cutting during the closing of the blade. These loads are transmitted by the balls between the ball screw and the ball nut, in the manner described above. The particular kinematics of this transmission prevents, during the opening or closing movement of the blade, maintaining the cam pivot in the axis of the ball screw and the latter thus sustains radial loads, that is to say perpendicular to its axis. These loads tend to bend the ball screw relative to its axis. The radial loads are essentially due to the fact that the rods which connect the ball nut to the cam of the cutting element do not remain constantly parallel to the axis of the ball screw during the pivoting movement.

Several solutions are being considered for maintaining the axis of the ball screw.

One solution allowing the end of the ball screw to be left free consists of providing a single bearing, and in particular a roller bearing, to connect the ball screw to the tool housing. This bearing is mounted in proximity of the reduction gear so as not to hinder the movement of the ball nut. This solution does however require the bearing to be oversized in order to contain the radial loads of the ball screw. It also poses problems of space taken up, of cost and weight for a portable tool. Furthermore, the radial constraints of the ball screw are not necessarily contained in a satisfactory manner.

Another solution which facilitates better containment of the radial constraints consists of connecting the ball screw to the housing of the cutting tool through the intermediary of two bearings mounted at the two ends of the ball screw respectively. This solution ensures good stability of the ball screw but may pose alignment problems of the bearings. It also poses problems with respect to space requirements and limitation of the track of the ball nut at the end of the ball screw. Finally, it requires a more complex design of the cutting blade, and in particular of its cam, resulting in a heavier weight.

A recent solution which is not exclusive of the preceding one is described in document EP2786845. It consists of providing the ball screw with an asymmetric oblique bearing supporting a radial offset of the ball screw axis. Such a solution remains subject to limits in terms of cost, space requirements and weight. In any case, this solution involves also a very significant take-up of the radial loads by the reduction gear.

Space requirements and weight of the various elements are in fact important parameters in the production of portable tools.

### DISCLOSURE OF THE INVENTION

The purpose of the present invention is to propose a portable power tool that is not hampered by the difficulties mentioned above.

One particular aim of the invention is to reduce the size and space requirement of the reducing gear and bearings used to maintain the ball screw in the tool housing.

Another aim of the invention is to propose a ball-screw assembly capable of adequately containing the radial stresses so as to render superfluous a bearing at the distal end of the ball-screw, i.e. at the end opposite the reduction gear.

Another aim of the invention is to propose a compact, lightweight tool with a ball screw-nut mechanism allowing a maximum travel of the ball nut.

One more aim of the invention is to propose a portable power tool that operates with less transmission noise.

In order to achieve these goals, the invention proposes more precisely a portable power tool which comprises, in a housing:
an electric motor with a drive shaft;
an epicyclic reduction gear with planet pinions, engaged on a central pinion that is integral with the drive shaft of the electric motor, the reduction gear being provided with an output shaft that is rigidly integral with the ball screw of a ball-screw-nut mechanism and coaxial to the ball-screw;
a supporting bearing connecting the output shaft with the housing.

In accordance with the invention, the tool comprises at least one stabilization bearing that is axially set off in relation to the support bearing. The stabilization bearing connects the output shaft of the reduction gear to the housing by at least one intermediate part chosen among: the drive shaft of the motor, the planet carrier axes of the reduction gear and planet pinions of the reduction gear forming track rollers.

Planet pinions are considered to be forming track rollers when, besides their function of transmitting movement, they are also configured for the transmission of radial stresses by a rolling contact with an associated rolling surface.

It should be mentioned that when the planet pinions of the reduction gear are not used as an intermediate part, and therefore do not intervene in the transmission of radial stresses, the planet pinions may be ordinary pinions which do not form track rollers.

The term bearing does not prejudge the type of bearing used. The support bearing(s), the stabilization bearing(s) as well as other bearings, for example, support bearings of the drive shaft may be chosen among bearings with or without rolling, ball, needle or roller bearings or combinations of these, depending on the specific stresses of the tool under consideration.

The reduction gear, the ball screw and the nut of the ball screw-nut mechanism are part of a transmission transmitting the movement of the motor to an active element of the tool such as a cutting element. This aspect is described in detail in the following description.

The output shaft is considered to be rigidly integral with the ball screw when it is attached to the ball screw in a manner that prohibits any relative angular movement between these components. In particular, the output shaft is considered to be rigidly integral with the ball screw when it is made of a single piece with the ball screw or when it constitutes the ball screw. In effect, according to a preferred implementation of a tool in conformance with the invention, the output shaft of the reduction gear may constitute the ball screw. In this case, the helical groove for the circulation of the balls is made directly on the output shaft of the reduction gear.

The supporting bearing is considered to be connecting the output shaft of the reduction gear to the housing when it serves to maintain the axial position of the output shaft relative to the housing, with the output shaft being free to rotate. This does not prejudge the mounting location of the support bearing. The support bearing may be mounted directly on the output shaft, for example in the immediate vicinity of the reduction gear. It may also be mounted on a bearing seat provided not directly on the output shaft but on the ball screw integral with the output shaft. Also, the support bearing may be received directly in the housing, or in an intermediate component, such as a bearing housing or an intermediate housing which connects the support bearing to the housing.

The stabilization bearing is considered to be axially set off relative to the support bearing when there exists between these bearings a measured offset along the common axis of the output shaft of the reduction gear and the ball screw or along an axis parallel to the axis of the output shaft of the reduction gear. The support bearing and the stabilization bearing(s) may be coaxial or not.

The stabilization bearing connects the output shaft of the reduction gear to the housing through the intermediary of one or several of the intermediate components mentioned above. These are in particular the drive shaft of the motor, the planet carrier axes of the reduction gear and/or the planet pinions of the reduction gear. This does not prejudge the existence or not of other supplementary intermediate components which contribute to maintaining the output shaft of the reduction gear on its axis.

For example, if the stabilization bearing is connected to the housing through the intermediary of the drive shaft of the electric motor, it is understood that the drive shaft of the electric motor is not in direct contact with the tool housing. In effect, the motor shaft may itself be received in the housing through the intermediary of one or several bearings.

According to one possible implementation of a tool according to the invention the output shaft of the epicyclic reduction gear may feature an axial boring turned toward the electric motor. In this case, the drive shaft of the electric motor may present one end received in the axial boring of the output shaft through the intermediary of the stabilization bearing.

The stabilization bearing is then seated in the axial boring. In this case, the output shaft of the reduction gear, its axial boring, the stabilization bearing and the drive shaft of the motor may be coaxial.

The stabilization bearing, offset relative to the support bearing of the output shaft of the reduction gear, makes it possible to relieve the support bearing of a portion of the radial loads sustained by the ball screw, by transmitting them to the drive shaft of the electric motor. These loads are then transmitted to the tool housing through the intermediary of one or several bearings of the drive shaft of the electric motor, as already mentioned.

The support bearing of the output shaft of the reduction gear is preferably situated in the vicinity of the reduction gear so as not to take up the space intended for the ball screw. This bearing, relieved of a portion of the radial stresses sustained by the ball screw may thus be of a smaller size, and the end of the ball screw, opposite the reduction gear, may be devoid of a bearing.

In other words, the end of the ball screw may be free which increases the length of the ball screw available for the travel of the ball nut, while conserving the compactness of the tool.

The concentric character of the stabilization bearing inside the axial boring of the output shaft of the reduction gear is likewise a characteristic which contributes to the compactness of the transmission.

According to another possible implementation of the tool in accordance with the invention, the stabilization bearing is mounted on a portion of the drive shaft of the electric motor which is located between the electric motor and the central pinion of the reduction gear. In this case, the stabilization bearing may be connected to the output shaft of the reduction gear through the intermediary of the planet carrier axes.

In particular, the planet carrier axes may form an anchorage on the output shaft for a receiving piece of the stabilization bearing.

The stabilization bearing thus transmits a portion of the radial forces sustained by the ball screw, and hence by the output shaft of the reduction gear, towards the motor shaft. The forces are then transmitted to the housing by the support bearings of the motor shaft.

In this implementation, the axial offset between the support bearing and the stabilization bearing may be greater than in an implementation where the stabilization bearing is seated in a boring of the end of the output shaft of the reduction gear. This offset, if it has been obtained at the price of a slightly less compact transmission, allows enlarging a lever arm between the support and the stabilization bearings to contain, even better, the radial forces acting on the ball screw and the output shaft of the reduction gear.

According to another possible implementation of a tool in conformance with the invention, the planet carrier axes may each be provided respectively with a stabilization bearing of the output shaft. In this case, the stabilization bearings are in rolling contact with a running ring of the housing.

The planet carrier axes are rigidly integral with the output shaft to the extent that they ensure the actuation of the output shaft in the epicyclic reduction gear. In this implementation, they are used to transfer the radial stresses of the ball screw and the output shaft of the reduction gear towards the housing, through the intermediary of the running ring.

The running ring may be constituted directly by the housing or may be an insert mounted in the housing and fixed relative to the housing.

The number of planet carrier axes is generally equals to three or more. It is thus possible to use several stabilization bearings and thereby distribute the transmission of stabilization stresses towards the housing. The bearings can be smaller than in a configuration with a single stabilization bearing.

According to yet another possible implementation of a tool in accordance with the invention, related to the preceding one, but in which the pinions form rollers, the planet pinions may each present a cylindrical shoulder with a diameter essentially equal to the pitch diameter of the pinion. The shoulder of the planet pinions forms a tread in rolling contact with a running ring integral with the housing. In this way the planets gears, beside their function of transmitting the movement in the epicyclic reduction gear, also serve as running rollers. In this case, each planet pinion constitutes, with its planet carrier axis, a stabilization bearing. This implementation is particularly economical to the extent that the planet pinions directly constitute the bearings with their respective axes. It does however require precise dimensioning of the pinion shoulders. As a matter of fact, if the shoulder presented a diameter different from the pitch diameter of the pinions, parasitic friction due to slipping would be occurring between the shoulder and the running ring.

The drive shaft of the motor is connected to the housing by at least one bearing called “motor bearing” which is distinct from the stabilization bearing. When the motor shaft is used as an intermediate part to receive the stabilization bearing and/or to transmit all or part of the radial stresses of the ball screw towards the housing, these stresses are taken into account for proper sizing of the motor bearing(s). The motor shaft is preferably supported by two motor bearings, for example at each end of the rotor.

It is also possible to consider supporting the motor shaft by only one bearing, on its end opposite the epicyclic reduction gear. This option is especially practicable for the first implementation mentioned above in which the stabilization bearing receives the motor shaft in an axial boring of the output shaft. It is also practicable when a number of stabilization bearings come into direct rolling contact with a running ring that is integral with the housing.

The various bearings mentioned, in particular the support bearing, the stabilization bearing(s), and the motor bearing(s) may be roller bearings or not. They may in particular be ball, needle or roller bearings or even a combination of these.

The support bearing of the output shaft of the reduction gear preferably includes a needle or roller bushing. The fact of supporting the output shaft of the reduction gear with a needle or roller bushing allows supporting a portion of the radial stresses sustained by the ball screw and the output shaft of the reduction gear. This design partially relieves the stabilization rolling bearing.

The tool may also feature one or several thrust needle bearings cooperating with the output shaft of the epicyclic reduction gear in order to stop or limit an axial movement of the output shaft and support the axial loads of the transmission. The thrust needle bearing may be configured, for example, to come into contact with a backing flange, a plastic ring or also an adapted shoulder of the output shaft.

It serves to transmit to the housing the axial loads supported by the ball screw and the output shaft of the reduction gear. The axial loads are essentially due to the stresses of opening and closing the cutting element in the case of a tool such as a pruning shear or a metal sheet shear.

The ball screw-nut mechanism may feature a ball nut which is mobile in translation relative to an axis of the ball screw and connected to an active element such as a cutting element. In the particular case of a pruning shear or a sheet metal shear, the ball nut may be connected to a pivoting blade and more precisely to an actuator cam of the blade. The cam is provided for transforming the translatory movement of the ball nut into a pivoting movement of the blade. The ball nut may be connected to the cam by one or several rods, for example. The displacement of the ball nut along the ball screw thus actuates the opening or closing of the cutting element.

To the extent that the radial stresses sustained by the ball screw are transferred to the stabilization bearing in the manner described above, it is possible to omit a support bearing of the ball screw at its distal end, i.e. the end opposite the reduction gear and turned toward the active element. In this case the ball screw presents a free distal end.

This design frees the space occupied by a possibly present end bearing and enables the ball nut to travel with greater translatory amplitude on the ball screw. It is thus possible to design a more compact tool or a tool with an active element, and in particular the cutting element, that has a wider amplitude of opening.

Other characteristics and advantages of the invention will become clear in the description below with reference to the figures of the drawings. This description is given strictly for illustrating purposes and is not limiting.

### BRIEF DESCRIPTION OF THE FIGURES

FIG. 1 is a cross-section of an electric pruning shear according to the invention.

FIG. 2 is a cross-section of part of a motor and of a reduction gear of the pruning shear of FIG. 1 showing, at a larger scale, the layout of the support and stabilization bearings.

FIG. 3 is a schematic representation of a possible layout of the support and stabilization bearings according to the invention and corresponding to FIG. 1.

FIG. 4A is a schematic representation of another possible layout of the support and stabilization bearings according to the invention.

FIG. 4B is a cross-section along A-A of the device shown in FIG. 4A.

FIG. 5A is a schematic representation of another possible layout of the support and stabilization bearings according to the invention.

FIG. 5B is a cross-section along B-B of the device shown in FIG. 5A.

FIG. 6 is a schematic representation of another possible layout of the support and stabilization bearings according to the invention.

### DETAILED DESCRIPTION OF IMPLEMENTATIONS OF THE INVENTION

In the following description all identical or similar portions of the various figures are identified by the same reference signs. It is thus possible to refer from one figure to another. The figures are shown in free scale.

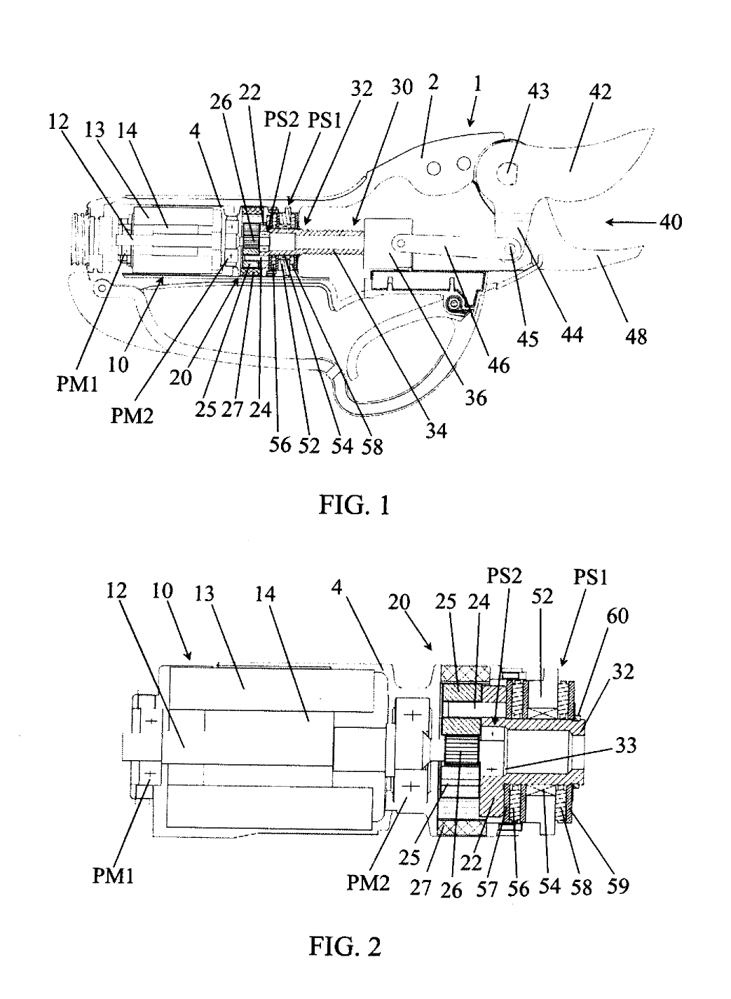

FIG. 1 represents in cross-section an electric pruning shear 1. The electric pruning shear 1 comprises a main housing 2 accommodating an electric motor 10, an epicyclic reduction gear 20 mounted on a drive shaft 12 of the motor, and a ball nut-screw mechanism 30.

The shaft 12 of the electric motor 10 is kept in the housing by two motor bearings PM1 and PM2 located on either side of the motor 10. The bearings PM1 and PM2 preferably consist of ball bearings.

In the example shown, the motor 10 includes a stator 13 and a rotor 14. The presence of an intermediate housing 4 receiving the motor 10 and the epicyclic reduction gear 20 can also be noted. The intermediate housing 4 is received in the main housing 2 of the electric pruning shear.

The epicyclic reduction gear 20, better visible on FIG. 2, comprises an output ring 22 that is rigidly integral with an output shaft 32. The output ring serves as support of the planet carrier axes 24 which carry the planet pinions 25. These are pinions engaged on a central pinion 26 integral with the drive shaft 12 of the motor 10, and running in a toothed running ring 27. The planet pinions 25 are simply called “planet gears” in the rest of the text.

The function of the epicyclic reduction gear is to confer to its output shaft 32 a reduced rotary speed relative to the rotary speed of the drive shaft 12 of the motor. The reduced rotary speed is accompanied by an increase in the rotary torque.

The output shaft 32 of the reduction gear is also part of the ball screw-nut mechanism 30 to the extent that a portion of this shaft, visible in FIG. 1, forms the ball screw 34. In effect, the free end of the output shaft is provided with a helical groove for the circulation of the balls. The ball screw 34 of the output shaft cooperates with a nut 36 through the intermediary of balls (not shown) which circulate in a ball race formed by the conjunction of the helical groove of the ball screw and a corresponding helical groove of the ball nut 36. The nut 36 is not shown in cross-section.

Rotation of the output shaft 32 thus activates a displacement of the ball nut 36. The nut moves in a direction which either brings it closer to or farther away from the motor depending on the sense of rotation of the output shaft.

The ball nut 36 of the ball screw-nut mechanism 30 is connected to a cutting element 40. This is, in the case of FIG. 1, a mobile blade 42 of the pruning shear, pivoting around a blade pivot 43. More precisely, the nut 36 is connected to a cam 44 of the mobile blade through the intermediary of a cam pivot 45 and two rods 46, only one of which is visible. Displacement of the nut 36 thus provokes the mobile blade 42 to pivot in a direction which either brings it closer to or farther away from a counter-blade 48 called a “hook”. In the example of FIG. 1 the mobile blade pivots while moving away from the hook when the ball nut 36 moves in the direction of the distal end of the ball screw 34. This movement corresponds to the opening of the pruning shear. Inversely, the mobile blade 42 pivots to close on the hook when the ball nut moves in the direction of the motor 10. This movement is a cutting motion.

The movements of opening and cutting of the cutting element generate, primarily on the ball screw 34 and the output shaft 32 of the reduction gear 30, axial loads which is to say parallel to the axis of the output shaft 32. They also generate radial loads, which is to say perpendicular to the axis of the output shaft 32. The radial loads are due, for example, to a transitory tilt of the rods relative to the axis of the output shaft 32 or of the ball screw 34. This is the case especially when the rods are connected to a pivoting cam 44 by a cam pivot 45 which cannot be maintained constantly in the axis of the ball screw, considering its circular trajectory centered on the blade pivot 43.

The output shaft 32 of the epicyclic reduction gear 20 is maintained in the main housing 2 by a support bearing PS1.

The function of the support bearing PS1 visible at a larger scale on FIG. 2 is to maintain the output shaft and to transfer toward the housing axial and radial loads applied to the output shaft 32 by the work of the cutting element. The loads are transmitted to the main housing 2 through the intermediary of a ring 52 of the support bearing PS1.

In the implementation shown the portions of the motor or of the reduction gear maintained in the main housing 2 of the pruning shear are maintained there through the intermediary of the intermediate housing 4 already mentioned. However, maintaining them directly in the main housing is conceivable.

The support bearing PS1 includes a first needle bushing forming a first needle roller bearing 54 rolling on the surface of the output shaft 32 of the reduction gear. The needles of the needle bearing 54 make it possible to transmit to the housing a portion of the radial loads sustained by the output shaft 32 through the intermediary of the ring 52. The support bearing PS1 includes a second needle cage which forms a needle thrust bearing 56. The needle thrust bearing 56 rolls against the output ring 22 of the reduction gear, and more precisely against a flange 57 resting on the ring. The needle thrust bearing 56 allows transferring toward the housing, via the ring 52, the axial loads of the output shaft 32 of the roller bearing during the cutting movement.

Finally, the support bearing PS1 includes a third needle cage forming another needle thrust bearing 58 resting against a second flange 59 maintained on the output shaft 32 by a plastic ring 60. The needle thrust bearing 58 allows transferring towards the housing axial loads sustained by the output shaft 32 of the reduction gear during an opening movement of the cutting element.

As shown in FIGS. 1 and 2, the end of the drive shaft 12 of the motor turned towards the epicyclic reduction gear is provided with a stabilization bearing PS2. The stabilization bearing is mounted in an axial boring 33 of the output shaft 32 of the epicyclic reduction gear. In the example shown, it is a ball bearing. The drive shaft 12 of the motor, the boring 33, the stabilization bearing PS2 and the output shaft 32 of the epicyclic reduction gear are coaxial.

As shown particularly in FIG. 2, the stabilization bearing PS2 is axially offset relative to the support bearing PS1 in the direction of the motor. The offset confers to these two bearings a good range to support the radial loads and stresses sustained by the ball screw 34 and hence the output shaft 32 of the epicyclic reduction gear. Use of the stabilization bearing PS2 greatly relieves the support bearing PS1 of the radial stresses and consequently affords improved maintenance of the ball screw and a more modest dimensioning of the support bearing PS1. It also avoids direct support of the radial loads by the planet gears of the reduction gear, thereby avoiding premature wear of the teeth of the various gears of the reduction gear (planet gears, running ring).

It should be noted in this regard that the ball screw 34 is without a bearing at its free end, as shown in FIG. 1. The absence of a bearing at the end of the ball screw allows, as mentioned earlier, a greater displacement of the travel of the ball nut and a more compact design of the tool.

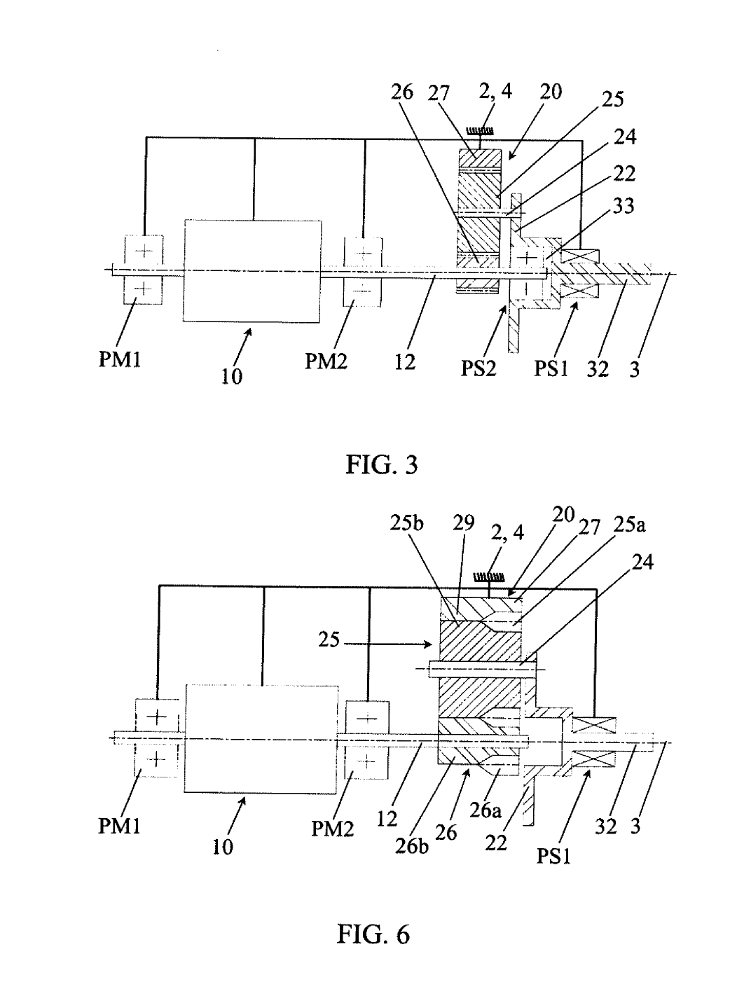

FIG. 3 is a schematic cross-section showing the layout of the major components involved in the stabilization of the output shaft in a design comparable to FIGS. 1 and 2. Here can be seen, centered on the same axis 3, the motor 10, the motor bearings PM1, PM2 supporting the drive shaft 12 of the motor, the central drive pinion 26 mounted on the drive shaft 12 of the motor 10, the stabilization bearing PS2 integrated in an axial boring 33 of the output shaft 32, the support ring 22 of the planet carrier axes 24, the support bearing PS1 and the output shaft 32 of the epicyclic reduction gear 30.

In FIG. 3 as well as in the following figures, the housing receiving the mechanical stresses and loads of the motor and the reduction gear is shown in a symbolic manner. It may be either the main housing 2 or the intermediate housing 4 received rigidly in the main housing. A double reference 2, 4 is therefore shown in the figures.

A planet gear 25 is mounted on a planet carrier axis 24 of the ring 22. It is driven in rotation by the central pinion 26 of the drive shaft 12 of the motor 10. The planet gear 25 is meshed on a toothed peripheral running ring 27 in which it can roll. The toothed running ring 27 is maintained fixed by the central housing 2 or by the intermediate housing 4. The running of the planet gear 25 in the toothed running ring 27 drives the planet gear in a circular movement around the axis 3 of the drive shaft. The movement of the planet gear 25 drives the output ring 22 which serves as support for the planet carrier axes, and the output ring 22 drives the output shaft 32 of the reduction gear of which it is an integral part.

FIG. 3 shows only a single planet gear 25 situated in the cut plane. Two more planet gears are situated outside of the cut plane and are not shown.

In general the reduction gear 30 comprises preferably a number of planet gears of three or more.

In a simplified implementation of the invention the second motor bearing PM2 may be omitted. In this case, the motor shaft is only supported by the first motor bearing PM1 located opposite the epicyclic reduction gear 30, and by the stabilization bearing PS2. The stabilization bearing PS2 is in effect maintained on the axis 3 by the output ring 22 integral with the output shaft 32, and by the support bearing PS1 connected to the main housing 2 or to the intermediate housing 4.

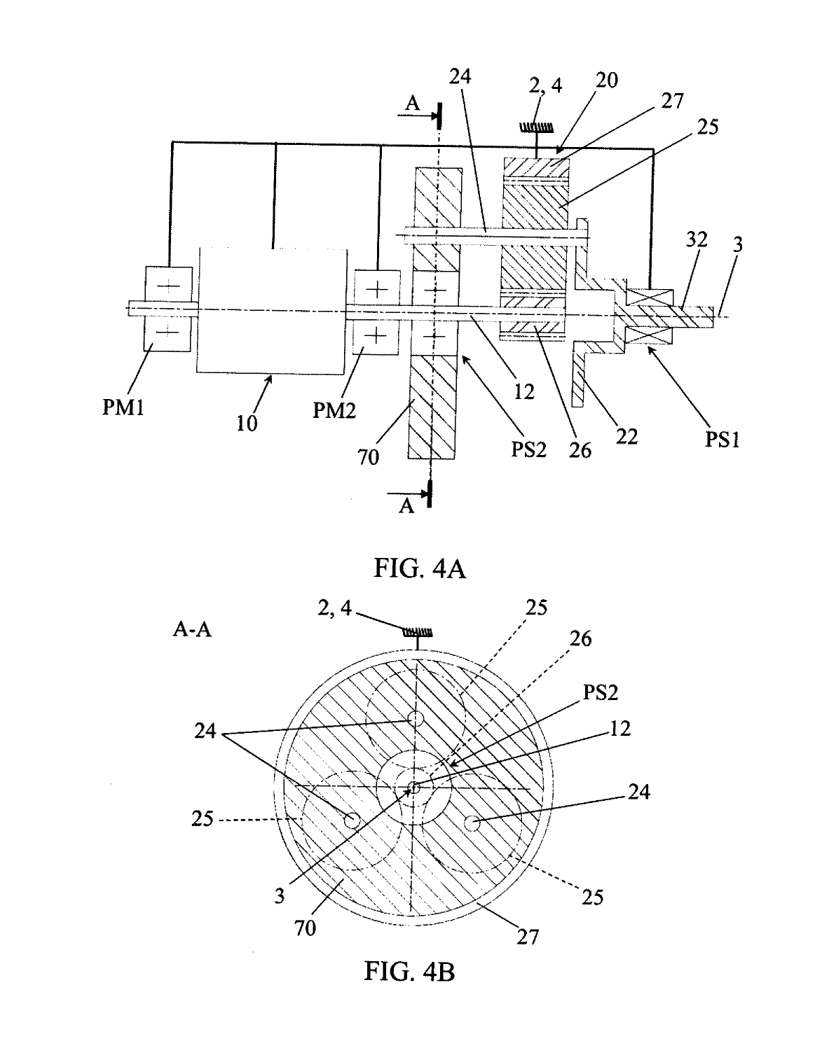

FIG. 4A is a schematic cross-section corresponding to another possible implementation of the invention in which a stabilization bearing PS2 connects the output shaft of the reduction gear to the housing through the intermediary of the planet carrier axes 24. The planet carrier axes are integral with the output shaft 32 through the intermediary of the output ring 22. Now, as shown in FIG. 4A, the axes are also received in a stabilization disk 70 mounted on the drive shaft 12 of the motor 10 through the intermediary of the stabilization bearing PS2. The stabilization disk 70 is rigidly integral with the planet carrier axes 24 and forms a seat for the stabilization bearing PS2.

The drive shaft 12 of the motor is itself connected to the housing through the intermediary of the motor bearings PM1 and PM2 already mentioned in reference to the preceding figures.

FIG. 4B is a view along a plane A-A of FIG. 4A. It shows in cross-section the stabilization disk 70 and the planet carrier axes 24 of three planet gears 25 of which only the pitch circles are indicated in broken lines. The planet gears 25 present a regular angular distribution at 120° around the axis 3 of the drive shaft 12. The stabilization bearing PS2 is indicated schematically. It connects the drive shaft 12 to the stabilization disk 70.

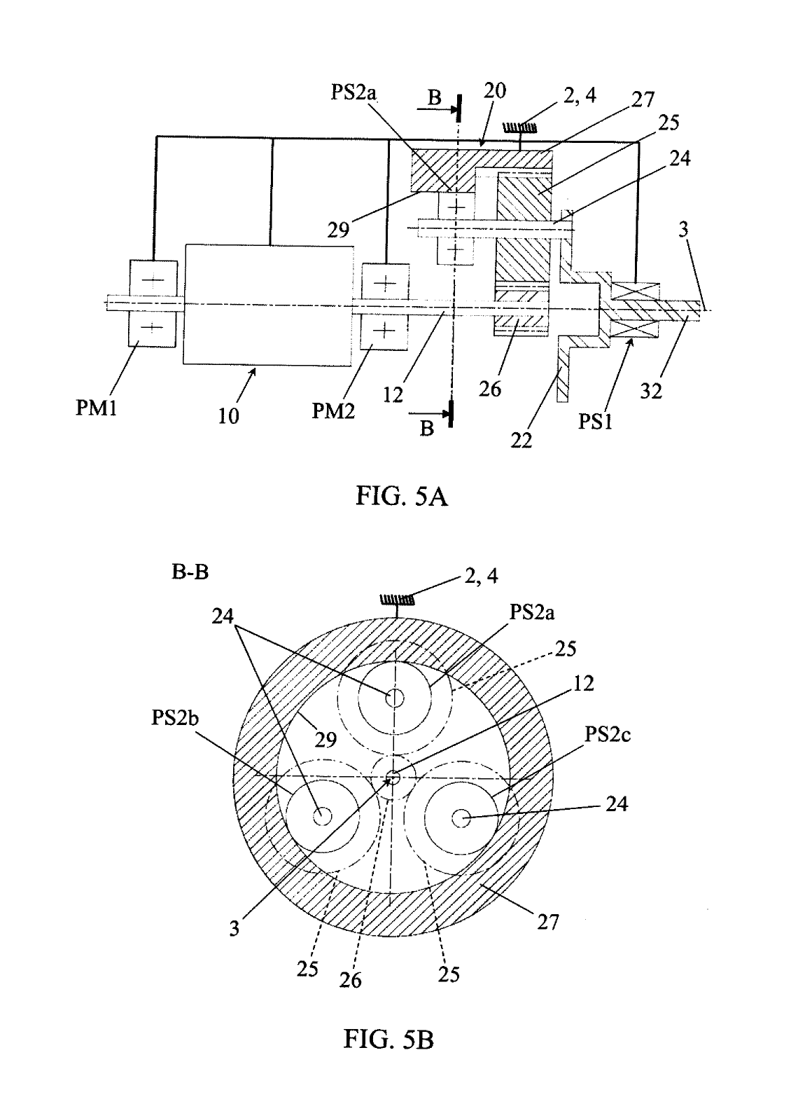

FIGS. 5A and 5B show a variant of the implementation of the invention in which several stabilization bearings are used. The stabilization bearings PS2a, PS2b, PS2c are always integral with the output shaft 32 of the epicyclic reduction gear 30 through the intermediary of the output ring 22 and the planet carrier axes 24 rigidly integral with the output ring 22. The stabilization bearings PS2a, PS2b, PS2c are mounted on the planet carrier axes, behind the planet gears, and run on a smooth runner ring 29. The term “smooth” does not prejudge the condition of the surface of the so-called smooth runner ring, but simply distinguishes it from the toothed runner ring 27. The smooth runner ring 29 is in effect without teeth and presents a peripheral and cylindrical running band for the bearings. The smooth runner ring 29 may be formed by a shoulder of the toothed runner ring 27. As stated before, the planet gears 25 are meshed on the toothed runner ring 27.

The bearings PS2a, PS2b, PS2c are, for example, ball or needle bearings. Bearings without rollers can also be used.

FIG. 5B shows the bearings PS2a, PS2b, PS2c along the cut B-B of FIG. 5A. The pitch circles of the planet gears 25, as well as of the central pinion 26 are shown in broken lines.

FIG. 6 shows still another possibility of implementation in which the planet gears 25 directly form the stabilization bearings.

The planet bearings 25 of which only one is seen in cross-section on FIG. 6, present a toothing 25a extending only over a portion of their width. The toothing of the planet gear is meshed in a portion 26a of the equally toothed central pinion 26, and with a toothed roller ring 27. This mechanism is similar to the one described in reference to the preceding figures. The planet gears furthermore form, over a portion of their width, a roller with a shoulder forming a roller band 25b.

The roller band 25b of the planet gears is set to roll on a smooth roller ring 29 and on a corresponding roller band 26b of the central pinion 26. The smooth roller ring 29 is comparable to the one described in reference to FIGS. 5A and 5B. The smooth roller ring 29, the roller band 26b of the central pinion 26, just like the roller band 25b of the planet gear are without toothing.

The radial stresses sustained by the output shaft 32 of the epicyclic reduction gear are thus transmitted to the housing 2, 4 through the intermediary of the output ring 22, the planet carrier axes 24, the planet gears 25 forming the rollers, and the smooth roller ring 29. The stresses are also transmitted to the housing through the intermediary of the roller band 26b of the central pinion 26, the drive shaft 12 and the motor bearings PM1, PM2.

In this implementation, the planet pinions 25 also constitute stabilization bearings. It must be clearly stated that the diameter of the roller band 25b of the planet gears and the diameter of the roller band 26b of the central pinion 26 correspond to the pitch diameter of the portions 25a, 26a featuring toothing so as to avoid friction during the rolling. The same is true for the smooth roller ring 29 the diameter of which is matched to the roller pitch circle of the toothed roller ring 27.

In a simplified version the roller band 25b of the planet gears may be designed to roll only on the smooth roller ring 29 or only on the roller band 26b of the central pinion 26.

1. Portable power tool comprising, in a housing:
an electric motor with a drive shaft;
an epicyclic reduction gear with planet pinions meshed on a central pinion of the drive shaft of the electric motor, the reduction gear being equipped with an output shaft that is rigidly integral with a ball screw of a ball screw-nut mechanism and coaxial to the ball screw;
a support bearing connecting the output shaft to the housing characterized by:
at least one stabilization bearing, axially offset relative to the support bearing, the stabilization bearing connecting the output shaft of the epicyclic reduction gear to the housing by at least one intermediate part chosen among:
the drive shaft of the electric motor;
planet carrier axes of the epicyclic reduction gear; and
planet pinions of the epicyclic reduction gear, the planet pinions presenting, in this case, each a cylindrical shoulder with a diameter essentially equal to the pitch diameter of the pinion, the shoulder of the planet pinions forming a roller band and being respectively in rolling contact with a smooth-running ring, integral with the housing.

2. Portable power tool according to claim 1, in which the output shaft of the epicyclic reduction gear comprises an axial boring and in which the drive shaft of the electric motor presents one end received in the axial boring of the output shaft through the intermediary of the stabilization bearing.

3. Portable power tool according to claim 1, in which the stabilization bearing is mounted on a portion of the drive shaft of the electric motor located between the electric motor and the central pinion, the stabilization bearing being connected to the output shaft of the reduction gear through the intermediary of the planet carrier axes.

4. Portable power tool according to claim 1 in which the planet carrier axes are each provided respectively with a stabilization bearing of the output shaft, the stabilization bearings being in rolling contact with a smooth runner ring of the housing.

5. Portable power tool according to claim 1, in which the drive shaft of the motor is connected to the housing by at least one motor bearing, distinct from the stabilization bearing.

6. Portable power tool according to claim 1, in which the epicyclic reduction gear includes at least three planet pinions.

7. Portable power tool according to claim 1, in which the support bearing of the output shaft of the reduction gear includes either a needle bushing or a roller bushing.

8. Portable power tool according to claim 1, including at least one needle thrust bearing cooperating with the output shaft of the epicyclic reduction gear to prohibit an axial movement of the output shaft.

9. Portable power tool according to claim 1, in which the ball screw is made of a single piece with the output shaft of the epicyclic reduction gear.

10. Portable power tool according to claim 1, in which the ball screw presents a free distal end.

11. Portable power tool according to claim 1, in which the ball screw-nut mechanism comprises a mobile ball nut in translation relative to an axis of the ball screw, the nut being connected to a cutting element.

12. Portable power tool according to claim 11 in which the cutting element is a blade of a pruning shear, the ball nut being connected to an actuating cam of the blade of a pruning shear.

13. Portable power tool according to claim 11 in which the cutting element is a blade of a sheet metal shear, the ball screw being connected to an actuating cam of the blade of a sheet metal shear.

14. Portable power tool according to claim 1, in which the output shaft of the epicyclic reduction gear constitutes the ball screw.

15. (canceled)
